(19) United States
(12) Patent Application Publication
(10) Pub. No.: US 2025/0008399 A1
(43) Pub. Date: Jan. 2, 2025

(54) ENHANCEMENT ON TN CELL AND NTN CELL RESELECTION

(71) Applicant: Apple Inc., Cupertino, CA (US)

(72) Inventors: Fangli Xu, Beijing (CN); Naveen Kumar R. Palle Venkata, San Diego, CA (US); Yuqin Chen, Beijing (CN); Dawei Zhang, Saratoga, CA (US); Haijing Hu, Los Gatos, CA (US); Ralf Rossbach, Munich (DE); Peng Cheng, Beijing (CN); Ping-Heng Kuo, London (GB)

(73) Assignee: Apple Inc., Cupertino, CA (US)

(21) Appl. No.: 18/263,880

(22) PCT Filed: Aug. 8, 2022
(86) PCT No.: PCT/CN2022/110966

§ 371 Date: Aug. 1, 2023

(51) Int. Cl. H04W 36/08; H04W 36/00

(52) U.S. Cl. CPC H04W 36/083; H04W 36/0061

(57) ABSTRACT

Provided is a method for a user equipment (UE). The UE obtains a cell reselection indication from a network device. The cell reselection indication indicates to the UE whether a terrestrial network (TN) cell or a non-terrestrial network (NTN) cell serves as a camping cell for which the UE performs cell reselection; The UE performs the cell reselection based on the cell reselection indication.

### TECHNICAL FIELD

This application relates generally to wireless communication systems, and more specifically to enhancement on terrestrial network (TN) cell and non-terrestrial network (NTN) cell reselection.

### BACKGROUND

Wireless mobile communication technology uses various standards and protocols to transmit data between a base station and a wireless mobile device. Wireless communication system standards and protocols can include the 3rd Generation Partnership Project (3GPP) long term evolution (LTE); fifth-generation (5G) 3GPP new radio (NR) standard; the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi. In 3GPP radio access networks (RANs) in LTE systems, the base station can include a RAN Node such as a Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE). In fifth generation (5G) wireless RANs, RAN Nodes can include a 5G Node, new radio (NR) node or g Node B (gNB), which communicate with a wireless communication device, also known as user equipment (UE).

### SUMMARY

According to an aspect of the present disclosure, a method for a user equipment (UE) is provided that comprises: obtaining, from a network device, a cell reselection indication, wherein the cell reselection indication indicates to the UE whether a terrestrial network (TN) cell or a non-terrestrial network (NTN) cell serves as a camping cell for which the UE performs cell reselection; and performing the cell reselection based on the cell reselection indication.

According to an aspect of the present disclosure, a method for a network device is provided that comprises: generating a cell reselection indication, wherein the cell reselection indication indicates to a user equipment (UE) whether a terrestrial network (TN) cell or a non-terrestrial network (NTN) cell serves as a camping cell for which the UE performs cell reselection; and storing the cell reselection indication in a memory for transmission to the UE.

According to an aspect of the present disclosure, an apparatus is provided that includes one or more processors configured to perform steps of any of the methods according to the present disclosure.

According to an aspect of the present disclosure, a computer readable medium is provided that has computer programs stored thereon, which when executed by one or more processors, cause an apparatus to perform steps of any of the methods according to the present disclosure.

According to an aspect of the present disclosure, a computer program product is provided that includes computer programs which, when executed by one or more processors, cause an apparatus to perform steps of any of the methods according to the present disclosure.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 is a block diagram of a system including a base station and a user equipment (UE) in accordance with some embodiments.

FIG. 2 illustrates exemplary scenario for terrestrial network (TN) and non-terrestrial network (NTN) deployment in accordance with some embodiments.

FIG. 3 illustrates a flowchart for an exemplary method for a user equipment in accordance with some embodiments.

FIG. 4 illustrates a flowchart for an exemplary method for a network device in accordance with some embodiments.

FIG. 5 illustrates a flowchart for exemplary steps for TN cell and NTN cell reselection in accordance with some embodiments.

FIG. 6 illustrates another flowchart for exemplary steps for TN cell and NTN cell reselection in accordance with some embodiments.

FIG. 7 illustrates an exemplary block diagram of an apparatus for a UE in accordance with some embodiments.

FIG. 8 illustrates an exemplary block diagram of an apparatus for a network device in accordance with some embodiments.

FIG. 9 illustrates example components of a device in accordance with some embodiments.

FIG. 10 illustrates example interfaces of baseband circuitry in accordance with some embodiments.

FIG. 11 illustrates components in accordance with some embodiments.

FIG. 12 illustrates an architecture of a wireless network in accordance with some embodiments.

### DETAILED DESCRIPTION

In the present disclosure, a “base station” can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC), and/or a 5G Node, new radio (NR) node or g Node B (gNB), which communicate with a wireless communication device, also known as user equipment (UE). Although some examples may be described with reference to any of E-UTRAN Node B, an eNB, an RNC and/or a gNB, such devices may be replaced with any type of base station.

In wireless communication, there are terrestrial networks (TNs) and non-terrestrial networks (NTNs). Unlike TNs, NTNs refer to networks, or segments of networks, using non-terrestrial network entities, for example, airborne or spaceborne vehicles for transmission.

In related technologies, the wireless network does not formulate specific solutions for the terrestrial network-non-terrestrial network (NTN-TN) interworking scenario. That means, while being in the NTN-TN interworking scenario, a user equipment (UE) may waste power switching from camping on an unsuitable type of network to camping on another type of network that may facilitate higher quality of communication for the UE.

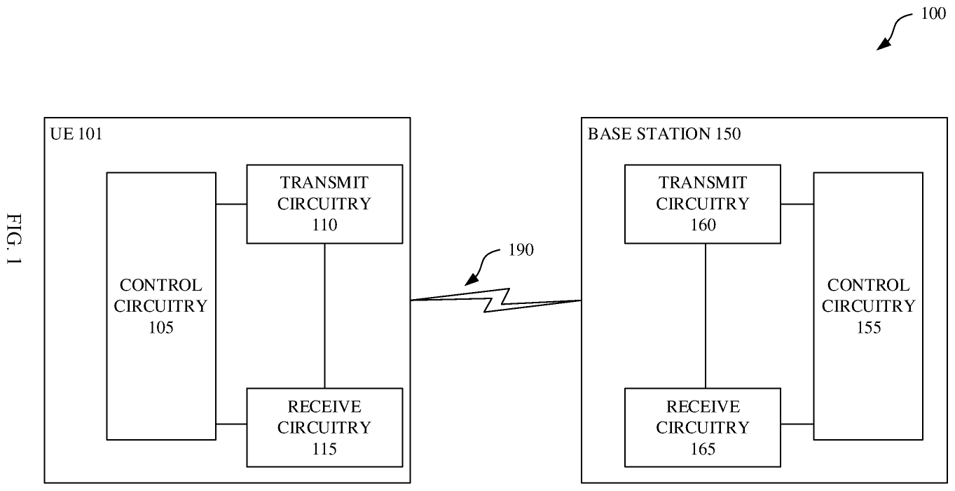

FIG. 1 illustrates a wireless network 100, in accordance with some embodiments. The wireless network 100 includes a UE 101 and a base station 150 connected via an air interface 190.

The UE 101 and any other UE in the system may be, for example, laptop computers, smartphones, tablet computers, printers, machine-type devices such as smart meters or specialized devices for healthcare monitoring, remote security surveillance, an intelligent transportation system, or any other wireless devices with or without a user interface. The base station 150 provides network connectivity to a broader network (not shown) to the UE 101 via the air interface 190 in a base station service area provided by the base station 150. In some embodiments, such a broader network may be a wide area network operated by a cellular network provider, or may be the Internet. Each base station service area associated with the base station 150 is supported by antennas integrated with the base station 150. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the base station 150, for example, includes three sectors each covering a 120 degree area with an array of antennas directed to each sector to provide 360 degree coverage around the base station 150.

The UE 101 includes control circuitry 105 coupled with transmit circuitry 110 and receive circuitry 115. The transmit circuitry 1 10 and receive circuitry 115 may each be coupled with one or more antennas. The control circuitry 105 may be adapted to perform operations associated with MTC. In some embodiments, the control circuitry 105 of the UE 101 may perform calculations or may initiate measurements associated with the air interface 190 to determine a channel quality of the available connection to the base station 150. These calculations may be performed in conjunction with control circuitry 155 of the base station 150. The transmit circuitry 110 and receive circuitry 115 may be adapted to transmit and receive data, respectively. The control circuitry 105 may be adapted or configured to perform various operations such as those described elsewhere in this disclosure related to a UE. The transmit circuitry 110 may transmit a plurality of multiplexed uplink physical channels. The plurality of uplink physical channels may be multiplexed according to time division multiplexing (TDM) or frequency division multiplexing (FDM). The transmit circuitry 110 may be configured to receive block data from the control circuitry 105 for transmission across the air interface 190. Similarly, the receive circuitry 115 may receive a plurality of multiplexed downlink physical channels from the air interface 190 and relay the physical channels to the control circuitry 105. The uplink and downlink physical channels may be multiplexed according to TDM or FDM. The transmit circuitry 1 10 and the receive circuitry 1 15 may transmit and receive both control data and content data (e.g. messages, images, video, et cetera) structured within data blocks that are carried by the physical channels.

FIG. 1 also illustrates the base station 150, in accordance with various embodiments. The base station 150 circuitry may include control circuitry 155 coupled with transmit circuitry 160 and receive circuitry 165. The transmit circuitry 160 and receive circuitry 165 may each be coupled with one or more antennas that may be used to enable communications via the air interface 190.

The control circuitry 155 may be adapted to perform operations associated with MTC. The transmit circuitry 160 and receive circuitry 165 may be adapted to transmit and receive data, respectively, within a narrow system bandwidth that is narrower than a standard bandwidth structured for person to person communication. In some embodiments, for example, a transmission bandwidth may be set at or near 1.4 MHz. In other embodiments, other bandwidths may be used. The control circuitry 155 may perform various operations such as those described elsewhere in this disclosure related to a base station.

Within the narrow system bandwidth, the transmit circuitry 160 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is comprised of a plurality of downlink subframes.

Within the narrow system bandwidth, the receive circuitry 165 may receive a plurality of multiplexed uplink physical channels. The plurality of uplink physical channels may be multiplexed according to TDM or FDM. The receive circuitry 165 may receive the plurality of multiplexed uplink physical channels in an uplink super-frame that is comprised of a plurality of uplink subframes.

As described further below, the control circuitry 105 and 155 may be involved with measurement of a channel quality for the air interface 190. The channel quality may, for example, be based on physical obstructions between the UE 101 and the base station 150, electromagnetic signal interference from other sources, reflections or indirect paths between the UE 101 and the base station 150, or other such sources of signal noise. Based on the channel quality, a block of data may be scheduled to be retransmitted multiple times, such that the transmit circuitry 110 may transmit copies of the same data multiple times and the receive circuitry 1 15 may receive multiple copies of the same data multiple times.

The UEs and network devices (for example, base stations that support all kinds of serving cells including PCell and SCell, or base stations that act as the network device of PCell or SCell for communicating with the UE) described in the following embodiments may be implemented by the UE 101 and the base station 150 described in FIG. 1.

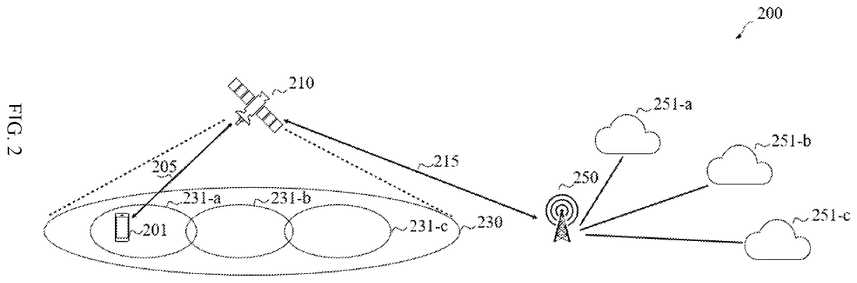

FIG. 2 illustrates exemplary scenario for terrestrial network (TN) and non-terrestrial network (NTN) deployment in accordance with some embodiments. The TN and NTN deployment 200 illustrated in FIG. 2 may accommodate with the wireless network 100 described in FIG. 1.

As can be seen from FIG. 2, the TN and NTN deployment 200 may comprise a non-terrestrial network entity 210, which may be either stationary or non-stationary, and a network device 250, which may typically be stationary. However, the present disclosure does not limit to this. The TN and NTN deployment 200 may comprise any number of non-terrestrial network entities and/or network devices.

According to some embodiments, the non-terrestrial network entity 210 may be an airborne or spaceborne vehicle for transmission. In the case where the non-terrestrial network entity 210 is an airborne vehicle, the non-terrestrial network entity 210 may be a high-altitude platforms (HAPS). In the case where the non-terrestrial network entity 210 is a spaceborne vehicle, the non-terrestrial network entity 210 may be a low earth orbit (LEO) satellite, a middle earth orbit (MEO) satellite, a geosynchronous-orbit (GEO) satellite, or a high earth orbit (HEO) satellite.

Typically, the non-terrestrial networks are involved in usage scenarios where mobile broadband needs and public safety needs in unserved/underserved areas are to be addressed. Mobile broadband or public safety needs are, for example, related to maritime, airplane or railway connectivity.

In NTN network, the coverage of a cell or a beam is typically much larger/wider than that in the TN network. As shown in FIG. 2, the coverage of an NTN cell 230 may be across multiple countries 231-a, 231-b, and 231-c, etc. However, the present disclosure does not limit to this. The coverage of an NTN cell 230 may be across any number of countries or jurisdictions. The NTN may broadcast within multiple public land mobile networks (PLMNs) and may broadcast multiple tracking area codes (TACs) per PLMN (for example, up to a total of 12) in one cell. For NTNs, supported UEs may be UEs with global navigation satellite system (GNSS) capabilities.

The link 205 between UE 201 and the non-terrestrial network entity 210, which is represented by a bidirectional arrow, is called a service link. The link 215 between the non-terrestrial network entity 210 and the network device 250, which is also represented by a bidirectional arrow, is called a feeder link. Typically, the payload of the non-terrestrial network entity 210 is transparent, meaning that no processing of signals occurs at the non-terrestrial network entity 210. The network device 250, which may be the base station 150 described in FIG. 1, may be associated with several core networks (CNs) 251-a, 251-b, and 251-c, etc. Note that three CNs are illustrated as being associated with the network device 250, however, the present disclosure does not limit to this. The network device 250 may be associated with any number of CNs.

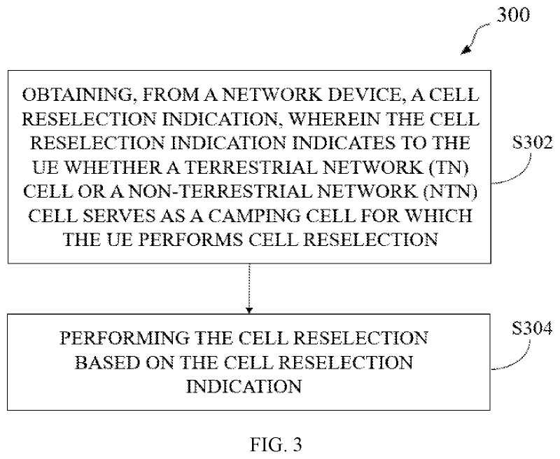

FIG. 3 illustrates a flowchart for an exemplary method for a user equipment in accordance with some embodiments. The method 300 illustrated in FIG. 3 may be implemented by the UE 101 described in FIG. 1.

In some embodiments, the method 300 for UE may include the following steps: S302, obtaining, from a network device, a cell reselection indication (for example, a cell reselection priority), wherein the cell reselection indication indicates to the UE whether a terrestrial network (TN) cell or a non-terrestrial network (NTN) cell serves as a camping cell for which the UE performs cell reselection; and S304, performing the cell reselection based on the cell reselection indication.

According to some embodiments, after obtaining the cell reselection priority, UE will first check the high priority network (for example, the TN network or the NTN network). But if the condition/radio quality of the high priority network is not good, UE may select the low priority network as a fallback. In other words, UE could select the low priority network for camping if the high priority network is not good enough from the radio quality perspective.

According to some embodiments of the present disclosure, by obtaining a cell reselection indication (for example, a cell reselection priority) indicating to a UE whether a terrestrial network (TN) cell or a non-terrestrial network (NTN) cell serves as a camping cell for which the UE performs cell reselection, the UE can be configured to perform the cell reselection based on the cell reselection indication, which enhances the NTN cell and TN cell reselection and enables further configuration of the cell reselection indication, thereby achieving UE power savings by specifying a suitable camping cell for the UE.

In the following, each step of the method 300 will be described in detail.

At step S302, the UE obtains, from a network device, a cell reselection indication, wherein the cell reselection indication (for example, the cell reselection priority) indicates to the UE whether a terrestrial network (TN) cell or a non-terrestrial network (NTN) cell serves as a camping cell for which the UE performs cell reselection.

As described in FIG. 2, the coverage of a cell or a beam in NTNs is typically much wider than that in the TNs. However, at least partially due to the larger coverage, the NTNs have longer communication delay than TNs. The service throughput provided by NTNs is lower than that of TNs. Therefore, it is proposed that different services be planned to be carried by different networks in the TN and NTN interworking deployment. Specifically, services with high data rate and/or strict latency requirement may for example be provided through TNs (e.g., TN cells), while services with low data rate and/or relaxed latency requirement may for example be provided through NTNs (e.g., NTN cells).

The following assumption may be considered that if all UEs initially camps on NTN cells and switches to TN cells by, for example, network dedicated signaling after the UEs enter CONNECTED state, the burden of the NTN as well as the latency for the service establishment would be drastically increased. To avoid this, by obtaining a cell reselection indication indicating to the UE whether a terrestrial network (TN) cell or a non-terrestrial network (NTN) cell serves as a camping cell for which the UE performs cell reselection, the UE can be configured to perform the cell reselection based on the cell reselection indication, thus camping on a serving cell that may facilitate not only the performance of UE itself (for example, power consumption) but also the communication quality provided by the TN and NTN interworking deployment.

At step S304, the UE performs the cell reselection based on the cell reselection indication.

The following assumption may also be considered that a UE initially camps on an NTN cell and triggers the connection in the NTN for file transfer protocol (FTP) service. Consequently, due to relatively low data rate as compared to TNs, the NTN handovers the UE to a TN (e.g., a TN cell). Then, the UE starts the FTP service after successful handover to the TN. The above assumption includes at least three stages which could have been bypassed by the cell reselection indication as introduced in step S302: (1) the RRC Connection between the UE and the NTN; (2) the awareness of NTN that UE's service is of large data amount (e.g., FTP service); and (3) RRC Reconfiguration signaling from the NTN to the UE to handover the UE to the TN followed by RRC ReconfigurationComplete signaling from the UE to the TN. To avoid this, by performing the cell reselection based on the cell reselection indication, the UE can be configured to camp on a suitable serving cell without any unwanted latency for the service establishment.

According to some embodiments, the cell reselection indication may comprise a cell reselection priority. According to some embodiments, the cell reselection priority may be predefined to impact cell selection/reselection between a TN cell and an NTN cell. According to some embodiments, the cell selection/reselection may be performed during an initial access procedure.

According to some embodiments, if one of the NTN and TN radio access technologies (RATs) has higher priority, UE will prioritize the cell associated with the one RAT with the higher priority to camp on if suitable NTN cell or TN cell could be founded.

According to some embodiments, there is provided another frequency reselection indication other than the cell reselection indication. According to some embodiments, both the cell reselection indication and the frequency reselection indication are used in the cell selection/reselection. According to some embodiments, the UE may receive the frequency reselection indication before the cell reselection indication. According to some embodiments, the UE may obtain the frequency reselection indication from the network device, wherein the frequency reselection indication indicates to the UE a range of frequencies to be used for communication; and perform the cell reselection based on the cell reselection indication within the range of frequencies indicated by the frequency reselection indication.

According to some embodiments, if the frequency reselection indication is firstly indicated to the UE followed by the cell reselection indication, the UE may only act on the cell reselection indication on the cell level if the NTN cells and TN cells are in the same frequency/band.

Note that, in the present disclosure, when reference is made to communication, it may refer to a bidirectional communication between a UE and a network (for example, transmitting to a network, receiving from a network), the communication between the UE and the network may include the communication between the UE/an apparatus of the UE and the network/a network device (node) in the network. Also note that, the expression “network device” and the expression “node” may be used herein interchangeably. In other words, when reference is made to “network device”, it may refer to “node”.

According to some embodiments, there is provided another frequency reselection indication other than the cell reselection indication. According to some embodiments, both the cell reselection indication and the frequency reselection indication are used in the cell selection/reselection. According to some embodiments, the UE may receive the cell reselection indication before the frequency reselection indication. According to some embodiments, the UE may determine the camping cell for which the UE performs the cell reselection in response to obtaining the cell reselection indication from the network device; obtain a frequency reselection indication from the network device, wherein the frequency reselection indication indicates to the UE a range of frequencies to be used for communication; determine whether the range of frequencies is shared by the camping cell; and perform the cell reselection based on the cell reselection indication in response to determining the range of frequencies is shared by the camping cell.

According to some embodiments, the cell reselection priority is communicated to the UE prior to the communication of the frequency reselection indication to the UE. And when the UE decides to select a TN cell based on the cell reselection priority, the UE will select TN frequency to perform the cell reselection. That is, if the TN cell and an NTN cell share the same frequency (e.g., carrier frequencies, frequency band), the UE will select the TN cell if it is of good quality.

According to some embodiments, the cell reselection priority is communicated to the UE prior to the communication of the frequency reselection priority to the UE. And when the UE decides to select an NTN cell based on the cell reselection priority, the UE will select NTN frequency to perform the cell reselection. That is, if the NTN cell and a TN cell share the same frequency (e.g., carrier frequencies, frequency band), the UE will select the NTN cell if it is of good quality.

According to some embodiments, the cell reselection indication comprises a cell reselection priority. According to some embodiments, the cell reselection priority may be configured via network signaling. According to some embodiments, the network signaling may be RRC signaling. As a result, the cell reselection priority may be configured via the RRC signaling, either cell specific or UE specific.

According to some embodiments, the network signaling may be a UE specific configuration. According to some embodiments, the network signaling may be provided as the UE specific configuration via UE dedicated signaling, for example, radio access control (RRC) signaling, media access control-control element (MAC-CE), or downlink control information (DCI), etc. According to some embodiments, the UE may acquire the UE specific configuration from RRCRelease message. According to some embodiments, the cell reselection indication may further comprise a validity timer during which the UE specific configuration is valid. According to some embodiments, the UE may discard the UE specific configuration upon expiration of the validity timer.

According to some embodiments, the network signaling may be a cell specific configuration of a cell on which the UE is currently camping. According to some embodiments, the UE may acquire the cell specific configuration in the system information block (SIB) of the currently camping cell.

In legacy cell reselection mechanism, the target of cell reselection is to keep UE always camped on the suitable cell(s). Cell reselection includes both intra-frequency cell reselection and inter-frequency cell reselection. The cell ranking criterion R for intra-frequency cell reselection and inter-frequency cell reselection is introduced below.

The cell ranking criterion Rs for serving cell and Rn for neighboring cells is defined by:

$$\begin{matrix}Rs = Qmeas , s + Qhyst - Qoffsettemp ; \\ Rn = Qmeas , n - Qoffset - Qoffsettemp ,\end{matrix}$$

where, Qmeas,s represents reference signal receiving power (RSRP) measurement quantity used in cell reselections, and Qoffsettemp represents offset temporarily applied to a cell as specified in TS 38.331 [3]. For intra-frequency, Qoffset equals to Qoffsets,n, if Qoffsets,n is valid, otherwise it equals to zero. And for inter-frequency, Qoffset equals to Qoffsets,n plus Qoffsetfrequency, if Qoffsets,n is valid, otherwise it equals to Qoffsetfrequency.

Table 1 below illustrates four typical cases where cell reselection is performed. As can be seen from Table 1, when the currently camping cell (i.e., the serving cell) and the neighboring cell (i.e., the target cell) are intra-frequency, if serving cell quality is below a threshold, then criterion R may be evaluated to decide whether the cell reselection is to be performed. When the currently camping cell and the neighboring cell are inter-frequency, if the currently camping cell has higher priority over the neighboring cell, then cell reselection to the neighboring cell may be performed in case that the neighboring cell quality is greater than a threshold for a given time duration. When the currently camping cell and the neighboring cell are inter-frequency, if the currently camping cell has equal priority with the neighboring cell, then criterion R may be evaluated with respect to the neighboring cell in case that the serving cell quality is below a threshold. When the currently camping cell and the neighboring cell are inter-frequency, if the neighboring cell has higher priority over the currently camping cell (i.e., the serving cell has low priority), then cell reselection to the neighboring cell may be performed in case that the serving cell quality is below a first threshold and the target cell quality is above a second threshold, wherein the first threshold may be same with or different than the second threshold.

TABLE 1
four cases where cell reselection is performed

| | Condition to trigger | |
|---|---|---|
| Case | Measurement | Re-selection criteria |
| Intra- | Serving cell quality | Criterion R |
| frequency | below threshold | |
| Inter- | N/A | cell quality > threshold for a time |
| frequency- | | duration |
| high priority | | |
| Inter- | Serving cell quality | Criterion R |
| frequency- | below threshold | |
| equal priority | | |
| Inter- | Serving cell quality | serving cell: quality < threshold; |
| frequency- | below threshold | target cell: quality > threshold |
| low priority | | |

According to some embodiments, there is provided TN specific Qoffsettn and/or NTN specific Qoffsetntn for checking whether the TN cell or the NTN cell is suitable for the UE to camp on. According to some embodiments, the TN specific Qoffsettn and/or the NTN specific Qoffsetntn may be provided to evaluating R criteria for the cell ranking.

For example, the cell ranking criteria Rs for serving cell and Rn for neighboring cells in terrestrial network (TN) and non-terrestrial network (NTN) deployment may be defined by:

$$\begin{matrix}Rs = Qmeas , s + Qhyst - Qoffsettemp \\ Rn = Qmeas , n - Qoffset - Qoffsettemp - Qoffsettn ( for TN neighboring cell ) \\ Rn = Qmeas , n - Qoffset - Qoffsettemp - Qoffsetntn ( for NTN neighboring cell )\end{matrix}$$

According to some embodiments, the cell reselection indication may comprise a TN/NTN specific offset parameter. According to some embodiments, the TN/NTN specific offset parameter may be used to provide an offset in evaluating a criterion. According to some embodiments, the criterion may determine whether the TN cell or the NTN cell is suitable to serve as the camping cell for which the UE may perform the cell reselection.

According to some embodiments, the core network (CN) may indicate to UE a dedicated priority for the TN cell and the NTN cell during the cell reselection. Assumption may be made that the CN may acquire all the UE subscription information (including NTN and TN, and the registered service) and provide a specific NTN or TN priority based on the whole picture. According to some embodiments, when UE performs registration procedure towards to the CN, the CN can configure the UE with the specific NTN or TN priority for the UE to perform the cell selection/reselection between the TN cell and the NTN cell.

According to some embodiments, the cell reselection indication may be obtained via non-access stratum (NAS) signaling and may comprise a UE dedicated priority for the TN cell and the NTN cell. According to some embodiments, the UE dedicated priority may be generated based on UE subscription information that is obtained from the UE.

According to some embodiments, the cell reselection indication may be provided in finer granularity to the UE via UE route selection policy (URSP) or via the NAS registration. According to some embodiments, the cell reselection indication may be provided per finer granularity in RRC signaling.

According to some embodiments, the cell reselection indication is generated per service. According to some embodiments, for UE triggered service request, UE may perform the cell reselection and camp on the corresponding cell for initial access based on the cell reselection indication (e.g., service-related NTN/TN cell priority).

According to some embodiments, the cell reselection indication is generated per slicing information. According to some embodiments, when upper layer triggers the initial access, UE may select the NTN cell or the TN cell for camping based on the triggered slicing information.

According to some embodiments, the cell reselection indication is generated per UE mobility state. According to some embodiments, a static UE or UE with low mobility state may first select the TN cell for camping.

According to some embodiments, the cell reselection indication is generated per UE battery status. According to some embodiments, the UE may select between TN cell and NTN cell based on its own battery status. For example, the UE may prioritize TN cells if its battery is running low.

According to some embodiments, the cell reselection indication is generated per UE location. According to some embodiments, the UE may select between TN cell and NTN cell based on its location. For example, the UE may prioritize TN cells if it is in proximity to a cell tower.

According to some embodiments, the cell reselection indication is generated per UE device type. According to some embodiments, the UEs with different device types may have different priorities with respect to TN cells or NTN cells. The priorities may be provided based on UE registration procedure by access and mobility management function (AMF). Moreover, the priorities may be updated via RRC signaling in a later stage. According to some embodiments, Redcap UE may prioritize TN cells over NTN cells for camping.

According to some embodiments, the cell reselection indication is generated per cell load. According to some embodiments, a threshold level may be generated based on the cell load. The UE may generate a random number and see if the value of its random number exceeds the threshold level or not, in order to determine if it should select TN cells or NTN cells.

Note that the above conditions for generating cell reselection indication are illustrated by way of example. The present disclosure does not limit to this. It should be apparent to those skilled in the art that any other suitable conditions for generating cell reselection indication may also be contemplated.

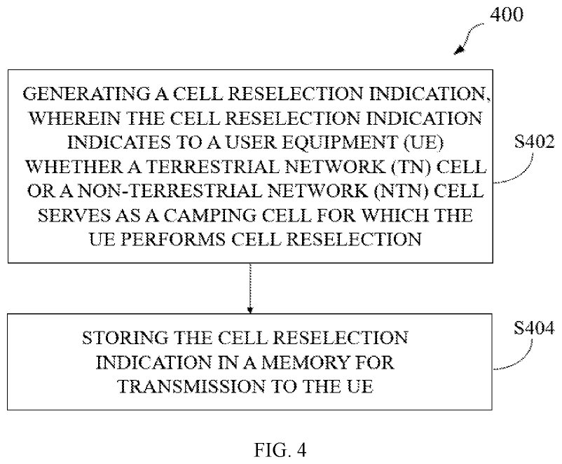

FIG. 4 illustrates a flowchart for an exemplary method for a network device in accordance with some embodiments. The method 400 illustrated in FIG. 4 may be implemented by the base station 150 described in FIG. 1. For example, the network device may be the network device of the base station 150.

In some embodiments, the method 400 for a network device may include the following steps: S402, generating a cell reselection indication, wherein the cell reselection indication indicates to a user equipment (UE) whether a terrestrial network (TN) cell or a non-terrestrial network (NTN) cell serves as a camping cell for which the UE performs cell reselection; and S404, storing the cell reselection indication in a memory for transmission to the UE.

According to some embodiments of the present disclosure, by generating a cell reselection indication indicating to a UE whether a terrestrial network (TN) cell or a non-terrestrial network (NTN) cell serves as a camping cell for which the UE performs cell reselection, the network device may facilitate UE to perform the cell reselection based on the cell reselection indication, which enhances the NTN cell and TN cell reselection and enables further configuration of the cell reselection indication, thereby achieving UE power savings by specifying a suitable camping cell for the UE.

In the following, each step of the method 400 will be described in detail.

At step S402, the network device generates a cell reselection indication, wherein the cell reselection indication indicates to a user equipment (UE) whether a terrestrial network (TN) cell or a non-terrestrial network (NTN) cell serves as a camping cell for which the UE performs cell reselection.

By generating a cell reselection indication indicating to the UE whether a terrestrial network (TN) cell or a non-terrestrial network (NTN) cell serves as a camping cell for which the UE performs cell reselection, the network device may facilitate the UE to perform the cell reselection based on the cell reselection indication, thus camping on a serving cell that may facilitate not only the performance of UE itself (for example, power consumption) but also the communication quality provided by the TN and NTN interworking deployment.

At step S404, the network device stories the cell reselection indication in a memory for transmission to the UE.

By storing the cell reselection indication, the network device may communicate to the UE via different signaling/messages in order for the UE to camp on a suitable serving cell without any unwanted latency for service establishment.

In some embodiments, the cell reselection indication may comprise a predefined cell reselection priority.

In some embodiments, the method 400 may further comprise: generating a frequency reselection indication, wherein the frequency reselection indication may indicate to the UE a range of frequencies to be used for communication.

In some embodiments, the cell reselection indication may comprise a cell reselection priority that is configured via network signaling.

In some embodiments, the cell reselection indication may comprise a TN/NTN specific offset parameter, and the TN/NTN specific offset parameter may be used to provide an offset in evaluating by the UE a criterion. In some embodiments, the criterion may determine whether the TN cell or the NTN cell is suitable to serve as the camping cell for which the UE may perform the cell reselection.

In some embodiments, the method 400 may further comprise: obtaining UE subscription information from the UE, wherein the cell reselection indication may be generated via non-access stratum (NAS) signaling and may comprise a UE dedicated priority for the TN cell and the NTN cell, and wherein the UE dedicated priority may be generated based on the UE subscription information.

In some embodiments, the cell reselection indication may be indicated in a paging message.

In some embodiments, the cell reselection indication may comprise a redirection message, In some embodiments, the method 400 may further comprise: obtaining, from the UE, a UE preference for the TN cell or the NTN cell; and generating the redirection message based on the UE preference.

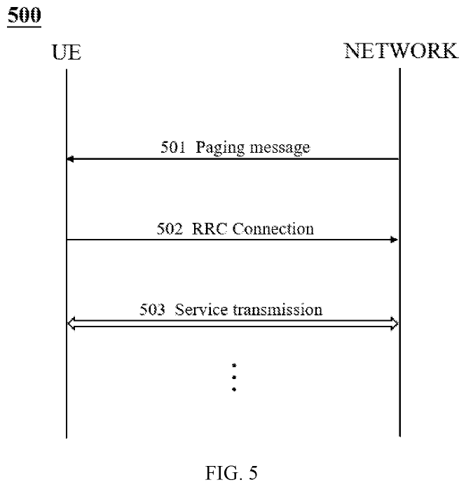

FIG. 5 illustrates a flowchart for exemplary steps for TN cell and NTN cell reselection in accordance with some embodiments.

In FIG. 5, the steps of the method for UE and the method for network device to realize enhancement on TN cell and NTN cell reselection according to some embodiments are shown. Note that those steps represented by thin line unidirectional arrow are performed in single direction (e.g., Step 501 and Step 502), and the step represented by hollow line bidirectional arrow is performed in both directions (e.g., Step 503).

At step 501, the UE may obtain paging message from the network device. In some embodiments, the paging message may comprise UE ID, cell reselection indication, etc.

At step 502, in response to obtaining the paging message, the UE may send an RRC Connection message to the network device if the type of its currently camping cell is different than the type of cell indicated in the cell reselection indication comprised in the paging message. The UE may then establish an RRC Connection with the type of cell indicated in the cell reselection indication of the paging message after conducting RRC Release procedure with the current camping cell.

At step 503, the UE and the network device may communicate (e.g., transmit and/or receive) data or control information with each other based on the established RRC Connection.

In some embodiments, the cell reselection indication may be indicated in a paging message.

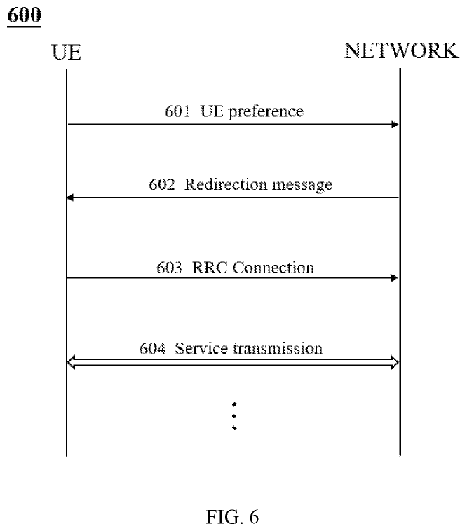

FIG. 6 illustrates another flowchart for exemplary steps for TN cell and NTN cell reselection in accordance with some embodiments.

In FIG. 6, the steps of the method for UE and the method for network device to realize enhancement on TN cell and NTN cell reselection according to some embodiments are shown. Note that those steps represented by thin line unidirectional arrow are performed in single direction (e.g., Step 601, Step 602, and Step 603), and the step represented by hollow line bidirectional arrow is performed in both directions (e.g., Step 604).

At step 601, the UE may indicate to the network device its preference for the TN cell or the NTN cell via message during the initial access with the current camping cell.

At step 602, in response to obtaining the UE preference, the network device may send to the UE redirection information to tell the UE to switch to corresponding cell per UE preference.

At step 603, in response to obtaining the redirection information, the UE may send an RRC Connection message to the network device. The UE may then establish an RRC Connection with the type of cell per UE preference after conducting RRC Release procedure with the current camping cell.

At step 604, the UE and the network device may communicate (e.g., transmit and/or receive) data or control information with each other based on the established RRC Connection.

In some embodiments, the cell reselection indication may comprise a redirection message, wherein the method 400 may further comprise: indicating, to the network device, a UE preference for the TN cell or the NTN cell; and obtaining, from the network device, the redirection message that is generated based on the UE preference.

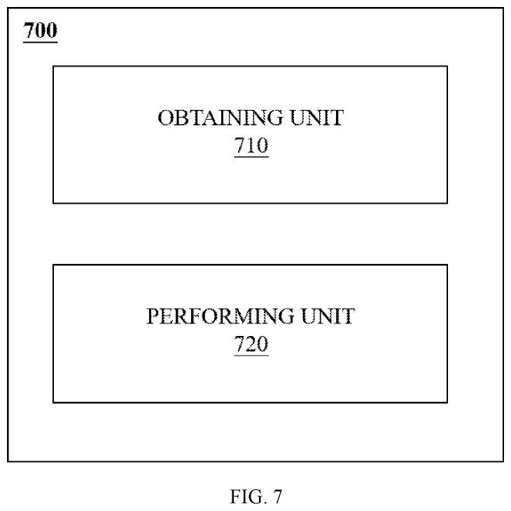

FIG. 7 illustrates an exemplary block diagram of an apparatus for a UE in accordance with some embodiments. The apparatus 700 illustrated in FIG. 7 may be used to implement the method 300 as illustrated in combination with FIG. 3.

As illustrated in FIG. 7, the apparatus 700 includes an obtaining unit 710 and a performing unit 720.

The obtaining unit 710 is configured to obtain, from a network device, a cell reselection indication, wherein the cell reselection indication indicates to the UE whether a terrestrial network (TN) cell or a non-terrestrial network (NTN) cell serves as a camping cell for which the UE performs cell reselection.

The performing unit 720 is configured to perform the cell reselection based on the cell reselection indication.

According to some embodiments of the present disclosure, by obtaining a cell reselection indication indicating to a UE whether a terrestrial network (TN) cell or a non-terrestrial network (NTN) cell serves as a camping cell for which the UE performs cell reselection, the UE can be configured to perform the cell reselection based on the cell reselection indication, which enhances the NTN cell and TN cell reselection and avoids potential UE power consumptions due to switching from camping on an unsuitable type of network to camping on another type of network that may facilitate higher quality of communication for the UE.

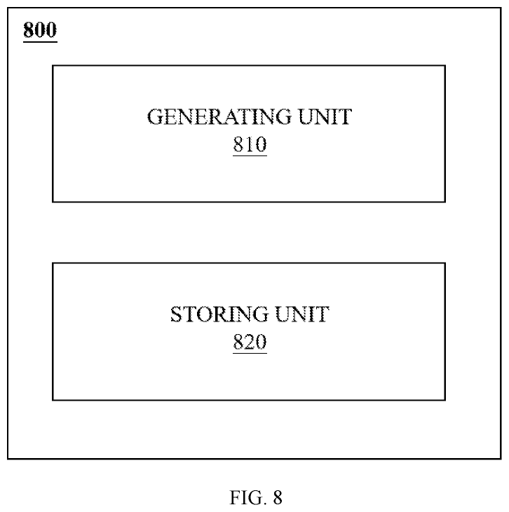

FIG. 8 illustrates an exemplary block diagram of an apparatus for a mobile base station in accordance with some embodiments. The apparatus 800 illustrated in FIG. 8 may be used to implement the method 400 as illustrated in combination with FIG. 4.

As illustrated in FIG. 8, the apparatus 800 includes a generating unit 810 and a storing unit 820.

The generating unit 810 is configured to generate a cell reselection indication, wherein the cell reselection indication indicates to a user equipment (UE) whether a terrestrial network (TN) cell or a non-terrestrial network (NTN) cell serves as a camping cell for which the UE performs cell reselection.

The storing unit 820 is configured to store the cell reselection indication in a memory for transmission to the UE.

According to some embodiments of the present disclosure, by generating a cell reselection indication indicating to a UE whether a terrestrial network (TN) cell or a non-terrestrial network (NTN) cell serves as a camping cell for which the UE performs cell reselection, the UE can be configured to perform the cell reselection based on the cell reselection indication, which enhances the NTN cell and TN cell reselection and avoids potential UE power consumptions due to switching from camping on an unsuitable type of network to camping on another type of network that may facilitate higher quality of communication for the UE.

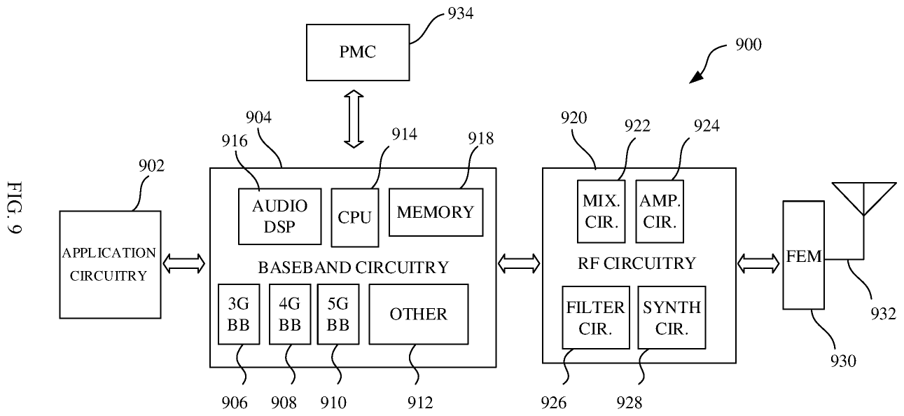

FIG. 9 illustrates example components of a device 900 in accordance with some embodiments. In some embodiments, the device 900 may include application circuitry 902, baseband circuitry 904, Radio Frequency (RF) circuitry (shown as RF circuitry 920), front-end module (FEM) circuitry (shown as FEM circuitry 930), one or more antennas 932, and power management circuitry (PMC) (shown as PMC 934) coupled together at least as shown. The components of the illustrated device 900 may be included in a UE or a RAN node. In some embodiments, the device 900 may include fewer elements (e.g., a RAN node may not utilize application circuitry 902, and instead include a processor/controller to process IP data received from an EPC). In some embodiments, the device 900 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 902 may include one or more application processors. For example, the application circuitry 902 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 900. In some embodiments, processors of application circuitry 902 may process IP data packets received from an EPC.

The baseband circuitry 904 may include circuitry such as, but not limited to, one or more single-core or multi-core processors. The baseband circuitry 904 may include one or more baseband processors or control logic to process baseband signals received from a receive signal path of the RF circuitry 920 and to generate baseband signals for a transmit signal path of the RF circuitry 920. The baseband circuitry 904 may interface with the application circuitry 902 for generation and processing of the baseband signals and for controlling operations of the RF circuitry 920. For example, in some embodiments, the baseband circuitry 904 may include a third generation (3G) baseband processor (3G baseband processor 906), a fourth generation (4G) baseband processor (4G baseband processor 908), a fifth generation (5G) baseband processor (5G baseband processor 910), or other baseband processor(s) 912 for other existing generations, generations in development or to be developed in the future (e.g., second generation (2G), sixth generation (6G), etc.). The baseband circuitry 904 (e.g., one or more of baseband processors) may handle various radio control functions that enable communication with one or more radio networks via the RF circuitry 920. In other embodiments, some or all of the functionality of the illustrated baseband processors may be included in modules stored in the memory 918 and executed via a Central Processing Unit (CPU 914). The radio control functions may include, but are not limited to, signal modulation/demodulation, encoding/decoding, radio frequency shifting, etc. In some embodiments, modulation/demodulation circuitry of the baseband circuitry 904 may include Fast-Fourier Transform (FFT), precoding, or constellation mapping/demapping functionality. In some embodiments, encoding/decoding circuitry of the baseband circuitry 904 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 904 may include a digital signal processor (DSP), such as one or more audio DSP(s) 916. The one or more audio DSP(s) 916 may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 904 and the application circuitry 902 may be implemented together such as, for example, on a system on a chip (SOC).

In some embodiments, the baseband circuitry 904 may provide for communication compatible with one or more radio technologies. For example, in some embodiments, the baseband circuitry 904 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 904 is configured to support radio communications of more than one wireless protocol may be referred to as multi-mode baseband circuitry.

The RF circuitry 920 may enable communication with wireless networks using modulated electromagnetic radiation through a non-solid medium. In various embodiments, the RF circuitry 920 may include switches, filters, amplifiers, etc. to facilitate the communication with the wireless network. The RF circuitry 920 may include a receive signal path which may include circuitry to down-convert RF signals received from the FEM circuitry 930 and provide baseband signals to the baseband circuitry 904. The RF circuitry 920 may also include a transmit signal path which may include circuitry to up-convert baseband signals provided by the baseband circuitry 904 and provide RF output signals to the FEM circuitry 930 for transmission.

In some embodiments, the receive signal path of the RF circuitry 920 may include mixer circuitry 922, amplifier circuitry 924 and filter circuitry 926. In some embodiments, the transmit signal path of the RF circuitry 920 may include filter circuitry 926 and mixer circuitry 922. The RF circuitry 920 may also include synthesizer circuitry 928 for synthesizing a frequency for use by the mixer circuitry 922 of the receive signal path and the transmit signal path. In some embodiments, the mixer circuitry 922 of the receive signal path may be configured to down-convert RF signals received from the FEM circuitry 930 based on the synthesized frequency provided by synthesizer circuitry 928. The amplifier circuitry 924 may be configured to amplify the down-converted signals and the filter circuitry 926 may be a low-pass filter (LPF) or band-pass filter (BPF) configured to remove unwanted signals from the down-converted signals to generate output baseband signals. Output baseband signals may be provided to the baseband circuitry 904 for further processing. In some embodiments, the output baseband signals may be zero-frequency baseband signals, although this is not a requirement. In some embodiments, the mixer circuitry 922 of the receive signal path may include passive mixers, although the scope of the embodiments is not limited in this respect.

In some embodiments, the mixer circuitry 922 of the transmit signal path may be configured to up-convert input baseband signals based on the synthesized frequency provided by the synthesizer circuitry 928 to generate RF output signals for the FEM circuitry 930. The baseband signals may be provided by the baseband circuitry 904 and may be filtered by the filter circuitry 926.

In some embodiments, the mixer circuitry 922 of the receive signal path and the mixer circuitry 922 of the transmit signal path may include two or more mixers and may be arranged for quadrature downconversion and upconversion, respectively. In some embodiments, the mixer circuitry 922 of the receive signal path and the mixer circuitry 922 of the transmit signal path may include two or more mixers and may be arranged for image rejection (e.g., Hartley image rejection). In some embodiments, the mixer circuitry 922 of the receive signal path and the mixer circuitry 922 may be arranged for direct downconversion and direct upconversion, respectively. In some embodiments, the mixer circuitry 922 of the receive signal path and the mixer circuitry 922 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 920 may include analog-to-digital converter (ADC) and digital-to-analog converter (DAC) circuitry and the baseband circuitry 904 may include a digital baseband interface to communicate with the RF circuitry 920.

In some dual-mode embodiments, a separate radio IC circuitry may be provided for processing signals for each spectrum, although the scope of the embodiments is not limited in this respect.

In some embodiments, the synthesizer circuitry 928 may be a fractional-N synthesizer or a fractional N/N+1 synthesizer, although the scope of the embodiments is not limited in this respect as other types of frequency synthesizers may be suitable. For example, synthesizer circuitry 928 may be a delta-sigma synthesizer, a frequency multiplier, or a synthesizer including a phase-locked loop with a frequency divider.

The synthesizer circuitry 928 may be configured to synthesize an output frequency for use by the mixer circuitry 922 of the RF circuitry 920 based on a frequency input and a divider control input. In some embodiments, the synthesizer circuitry 928 may be a fractional N/N+1 synthesizer.

In some embodiments, frequency input may be provided by a voltage controlled oscillator (VCO), although that is not a requirement. Divider control input may be provided by either the baseband circuitry 904 or the application circuitry 902 (such as an applications processor) depending on the desired output frequency. In some embodiments, a divider control input (e.g., N) may be determined from a look-up table based on a channel indicated by the application circuitry 902.

Synthesizer circuitry 928 of the RF circuitry 920 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 928 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 920 may include an IQ/polar converter.

The FEM circuitry 930 may include a receive signal path which may include circuitry configured to operate on RF signals received from one or more antennas 932, amplify the received signals and provide the amplified versions of the received signals to the RF circuitry 920 for further processing. The FEM circuitry 930 may also include a transmit signal path which may include circuitry configured to amplify signals for transmission provided by the RF circuitry 920 for transmission by one or more of the one or more antennas 932. In various embodiments, the amplification through the transmit or receive signal paths may be done solely in the RF circuitry 920, solely in the FEM circuitry 930, or in both the RF circuitry 920 and the FEM circuitry 930.

In some embodiments, the FEM circuitry 930 may include a TX/RX switch to switch between transmit mode and receive mode operation. The FEM circuitry 930 may include a receive signal path and a transmit signal path. The receive signal path of the FEM circuitry 930 may include an LNA to amplify received RF signals and provide the amplified received RF signals as an output (e.g., to the RF circuitry 920). The transmit signal path of the FEM circuitry 930 may include a power amplifier (PA) to amplify input RF signals (e.g., provided by the RF circuitry 920), and one or more filters to generate RF signals for subsequent transmission (e.g., by one or more of the one or more antennas 932).

In some embodiments, the PMC 934 may manage power provided to the baseband circuitry 904. In particular, the PMC 934 may control power-source selection, voltage scaling, battery charging, or DC-to-DC conversion. The PMC 934 may often be included when the device 900 is capable of being powered by a battery, for example, when the device 900 is included in an UE. The PMC 934 may increase the power conversion efficiency while providing desirable implementation size and heat dissipation characteristics.

FIG. 9 shows the PMC 934 coupled only with the baseband circuitry 904. However, in other embodiments, the PMC 934 may be additionally or alternatively coupled with, and perform similar power management operations for, other components such as, but not limited to, the application circuitry 902, the RF circuitry 920, or the FEM circuitry 930.

In some embodiments, the PMC 934 may control, or otherwise be part of, various power saving mechanisms of the device 900. For example, if the device 900 is in an RRC Connected state, where it is still connected to the RAN node as it expects to receive traffic shortly, then it may enter a state known as Discontinuous Reception Mode (DRX) after a period of inactivity. During this state, the device 900 may power down for brief intervals of time and thus save power.

If there is no data traffic activity for an extended period of time, then the device 900 may transition off to an RRC Idle state, where it disconnects from the network and does not perform operations such as channel quality feedback, handover, etc. The device 900 goes into a very low power state and it performs paging where again it periodically wakes up to listen to the network and then powers down again. The device 900 may not receive data in this state, and in order to receive data, it transitions back to an RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 902 and processors of the baseband circuitry 904 may be used to execute elements of one or more instances of a protocol stack. For example, processors of the baseband circuitry 904, alone or in combination, may be used to execute Layer 3, Layer 2, or Layer 1 functionality, while processors of the application circuitry 902 may utilize data (e.g., packet data) received from these layers and further execute Layer 4 functionality (e.g., transmission communication protocol (TCP) and user datagram protocol (UDP) layers). As referred to herein, Layer 3 may include a radio resource control (RRC) layer, described in further detail below. As referred to herein, Layer 2 may include a medium access control (MAC) layer, a radio link control (RLC) layer, and a packet data convergence protocol (PDCP) layer, described in further detail below. As referred to herein, Layer 1 may include a physical (PHY) layer of a UE/RAN node, described in further detail below.

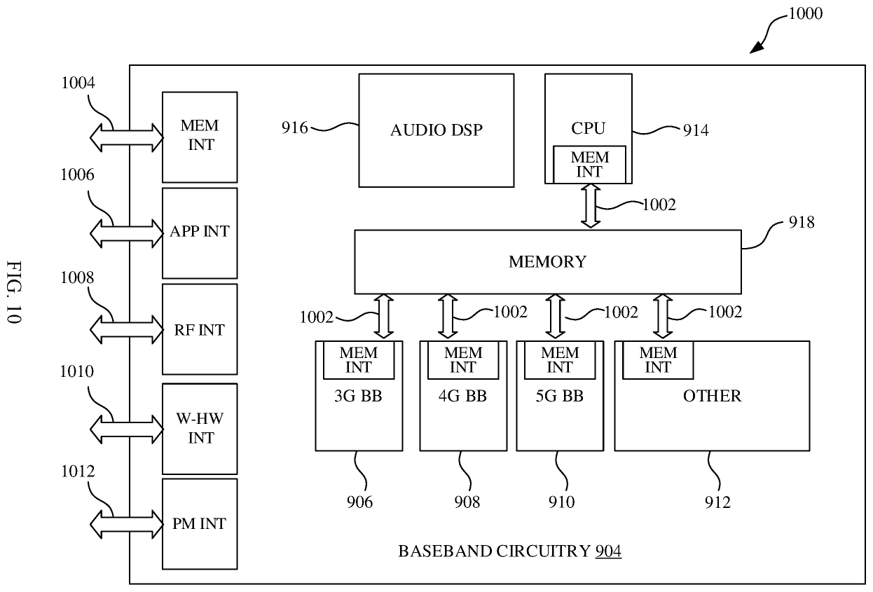

FIG. 10 illustrates example interfaces 1000 of baseband circuitry in accordance with some embodiments. As discussed above, the baseband circuitry 904 of FIG. 9 may include 3G baseband processor 906, 4G baseband processor 908, 5G baseband processor 910, other baseband processor(s) 912, CPU 914, and a memory 918 utilized by said processors. As illustrated, each of the processors may include a respective memory interface 1002 to send/receive data to/from the memory 918.

The baseband circuitry 904 may further include one or more interfaces to communicatively couple to other circuitries/devices, such as a memory interface 1004 (e.g., an interface to send/receive data to/from memory external to the baseband circuitry 904), an application circuitry interface 1006 (e.g., an interface to send/receive data to/from the application circuitry 902 of FIG. 9), an RF circuitry interface 1008 (e.g., an interface to send/receive data to/from RF circuitry 920 of FIG. 9), a wireless hardware connectivity interface 1010 (e.g., an interface to send/receive data to/from Near Field Communication (NFC) components, Bluetooth® components (e.g., Bluetooth® Low Energy), Wi-Fi® components, and other communication components), and a power management interface 1012 (e.g., an interface to send/receive power or control signals to/from the PMC 934.

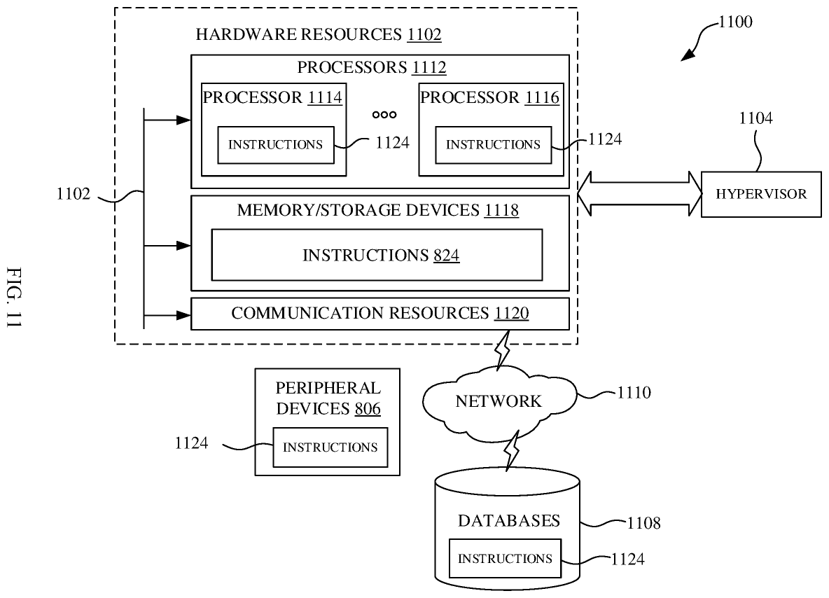

FIG. 11 is a block diagram illustrating components 1100, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1102 including one or more processors 1112 (or processor cores), one or more memory/storage devices 1118, and one or more communication resources 1120, each of which may be communicatively coupled via a bus 1122. For embodiments where node virtualization (e.g., NFV) is utilized, a hypervisor 1104 may be executed to provide an execution environment for one or more network slices/sub-slices to utilize the hardware resources 1102.

The processors 1112 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1114 and a processor 1116.

The memory/storage devices 1118 may include main memory, disk storage, or any suitable combination thereof. The memory/storage devices 1118 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1120 may include interconnection or network interface components or other suitable devices to communicate with one or more peripheral devices 1106 or one or more databases 1108 via a network 1110. For example, the communication resources 1120 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1124 may include software, a program, an application, an applet, an app, or other executable code for causing at least any of the processors 1112 to perform any one or more of the methodologies discussed herein. The instructions 1124 may reside, completely or partially, within at least one of the processors 1112 (e.g., within the processor's cache memory), the memory/storage devices 1118, or any suitable combination thereof. Furthermore, any portion of the instructions 1124 may be transferred to the hardware resources 1102 from any combination of the peripheral devices 1106 or the databases 1108. Accordingly, the memory of the processors 1112, the memory/storage devices 1118, the peripheral devices 1106, and the databases 1108 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

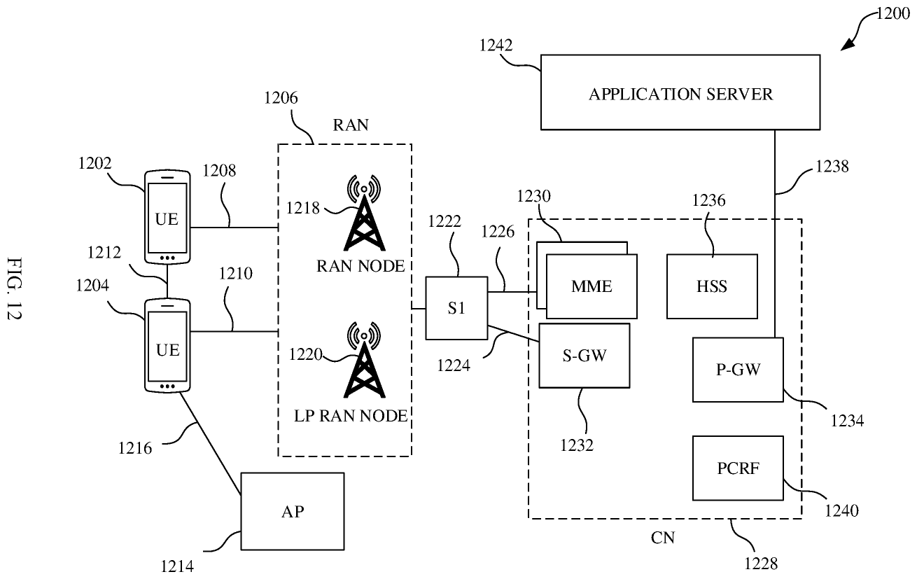

FIG. 12 illustrates an architecture of a system 1200 of a network in accordance with some embodiments. The system 1200 includes one or more user equipment (UE), shown in this example as a UE 1202 and a UE 1204. The UE 1202 and the UE 1204 are illustrated as smartphones (e.g., handheld touchscreen mobile computing devices connectable to one or more cellular networks), but may also include any mobile or non-mobile computing device, such as Personal Data Assistants (PDAs), pagers, laptop computers, desktop computers, wireless handsets, or any computing device including a wireless communications interface.

In some embodiments, any of the UE 1202 and the UE 1204 can include an Internet of Things (IoT) UE, which can include a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UE 1202 and the UE 1204 may be configured to connect, e.g., communicatively couple, with a radio access network (RAN), shown as RAN 1206. The RAN 1206 may be, for example, an Evolved Universal Mobile Telecommunications System (E-UMTS) Terrestrial Radio Access Network (E-UTRAN), a NextGen RAN (NG RAN), or some other type of RAN. The UE 1202 and the UE 1204 utilize connection 1208 and connection 1210, respectively, each of which includes a physical communications interface or layer (discussed in further detail below); in this example, the connection 1208 and the connection 1210 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UE 1202 and the UE 1204 may further directly exchange communication data via a ProSe interface 1212. The ProSe interface 1212 may alternatively be referred to as a sidelink interface including one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1204 is shown to be configured to access an access point (AP), shown as AP 1214, via connection 1216. The connection 1216 can include a local wireless connection, such as a connection consistent with any IEEE 802.11 protocol, wherein the AP 1214 would include a wireless fidelity (WiFi®) router. In this example, the AP 1214 may be connected to the Internet without connecting to the core network of the wireless system (described in further detail below).

The RAN 1206 can include one or more access nodes that enable the connection 1208 and the connection 1210. These access nodes (ANs) can be referred to as base stations (BSs), NodeBs, evolved NodeBs (eNBs), next Generation NodeBs (gNB), RAN nodes, and so forth, and can include ground stations (e.g., terrestrial access points) or satellite stations providing coverage within a geographic area (e.g., a cell). The RAN 1206 may include one or more RAN nodes for providing macrocells, e.g., macro RAN node 1218, and one or more RAN nodes for providing femtocells or picocells (e.g., cells having smaller coverage areas, smaller user capacity, or higher bandwidth compared to macrocells), e.g., a low power (LP) RAN node such as LP RAN node 1220.

Any of the macro RAN node 1218 and the LP RAN node 1220 can terminate the air interface protocol and can be the first point of contact for the UE 1202 and the UE 1204. In some embodiments, any of the macro RAN node 1218 and the LP RAN node 1220 can fulfill various logical functions for the RAN 1206 including, but not limited to, radio network controller (RNC) functions such as radio bearer management, uplink and downlink dynamic radio resource management and data packet scheduling, and mobility management.

In accordance with some embodiments, the UE 1202 and the UE 1204 can be configured to communicate using Orthogonal Frequency-Division Multiplexing (OFDM) communication signals with each other or with any of the macro RAN node 1218 and the LP RAN node 1220 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can include a plurality of orthogonal sub carriers.

In some embodiments, a downlink resource grid can be used for downlink transmissions from any of the macro RAN node 1218 and the LP RAN node 1220 to the UE 1202 and the UE 1204, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid includes a number of resource blocks, which describe the mapping of certain physical channels to resource elements. Each resource block includes a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 1202 and the UE 1204. The physical downlink control channel (PDCCH) may carry information about the transport format and resource allocations related to the PDSCH channel, among other things. It may also inform the UE 1202 and the UE 1204 about the transport format, resource allocation, and H-ARQ (Hybrid Automatic Repeat Request) information related to the uplink shared channel. Typically, downlink scheduling (assigning control and shared channel resource blocks to the UE 1204 within a cell) may be performed at any of the macro RAN node 1218 and the LP RAN node 1220 based on channel quality information fed back from any of the UE 1202 and UE 1204. The downlink resource assignment information may be sent on the PDCCH used for (e.g., assigned to) each of the UE 1202 and the UE 1204.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as enhanced resource element groups (EREGs). An ECCE may have other numbers of EREGs in some situations.

The RAN 1206 is communicatively coupled to a core network (CN), shown as CN 1228, via an SI interface 1222. In embodiments, the CN 1228 may be an evolved packet core (EPC) network, a NextGen Packet Core (NPC) network, or some other type of CN. In this embodiment the SI interface 1222 is split into two parts: the Sl-U interface 1224, which carries traffic data between the macro RAN node 1218 and the LP RAN node 1220 and a serving gateway (S-GW), shown as S-GW 1232, and an SI-mobility management entity (MME) interface, shown as SI-MME interface 1226, which is a signaling interface between the macro RAN node 1218 and LP RAN node 1220 and the MME(s) 1230.

In this embodiment, the CN 1228 includes the MME(s) 1230, the S-GW 1232, a Packet Data Network (PDN) Gateway (P-GW) (shown as P-GW 1234), and a home subscriber server (HSS) (shown as HSS 1236). The MME(s) 1230 may be similar in function to the control plane of legacy Serving General Packet Radio Service (GPRS) Support Nodes (SGSN). The MME(s) 1230 may manage mobility aspects in access such as gateway selection and tracking area list management. The HSS 1236 may include a database for network users, including subscription-related information to support the network entities' handling of communication sessions. The CN 1228 may include one or several HSS 1236, depending on the number of mobile subscribers, on the capacity of the equipment, on the organization of the network, etc. For example, the HSS 1236 can provide support for routing/roaming, authentication, authorization, naming/addressing resolution, location dependencies, etc.

The S-GW 1232 may terminate the SI interface 1222 towards the RAN 1206, and routes data packets between the RAN 1206 and the CN 1228. In addition, the S-GW 1232 may be a local mobility anchor point for inter-RAN node handovers and also may provide an anchor for inter-3GPP mobility. Other responsibilities may include lawful intercept, charging, and some policy enforcement.

The P-GW 1234 may terminate an SGi interface toward a PDN. The P-GW 1234 may route data packets between the CN 1228 (e.g., an EPC network) and external networks such as a network including the application server 1242 (alternatively referred to as application function (AF)) via an Internet Protocol (IP) interface (shown as IP communications interface 1238). Generally, an application server 1242 may be an element offering applications that use IP bearer resources with the core network (e.g., UMTS Packet Services (PS) domain, LTE PS data services, etc.). In this embodiment, the P-GW 1234 is shown to be communicatively coupled to an application server 1242 via an IP communications interface 1238. The application server 1242 can also be configured to support one or more communication services (e.g., Voice-over-Internet Protocol (VOIP) sessions, PTT sessions, group communication sessions, social networking services, etc.) for the UE 1202 and the UE 1204 via the CN 1228.

The P-GW 1234 may further be a node for policy enforcement and charging data collection. A Policy and Charging Enforcement Function (PCRF) (shown as PCRF 1240) is the policy and charging control element of the CN 1228. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1240 may be communicatively coupled to the application server 1242 via the P-GW 1234. The application server 1242 may signal the PCRF 1240 to indicate a new service flow and select the appropriate Quality of Service (QOS) and charging parameters. The PCRF 1240 may provision this rule into a Policy and Charging Enforcement Function (PCEF) (not shown) with the appropriate traffic flow template (TFT) and QoS class of identifier (QCI), which commences the QoS and charging as specified by the application server 1242.

### Additional Examples

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The following examples pertain to further embodiments.

Example 1 is a method for a user equipment (UE), comprising: obtaining, from a network device, a cell reselection indication, wherein the cell reselection indication indicates to the UE whether a terrestrial network (TN) cell or a non-terrestrial network (NTN) cell serves as a camping cell for which the UE performs cell reselection; and performing the cell reselection based on the cell reselection indication.

Example 2 is the method of Example 1, wherein the cell reselection indication comprises a predefined cell reselection priority.

Example 3 is the method of Example 1 or 2, further comprising: obtaining a frequency reselection indication from the network device, wherein the frequency reselection indication indicates to the UE a range of frequencies to be used for communication; and performing the cell reselection based on the cell reselection indication within the range of frequencies indicated by the frequency reselection indication.

Example 4 is the method of Example 1 or 2, further comprising: in response to obtaining the cell reselection indication from the network device, determining the camping cell for which the UE performs the cell reselection; obtaining a frequency reselection indication from the network device, wherein the frequency reselection indication indicates to the UE a range of frequencies to be used for communication; determining whether the range of frequencies is shared by the camping cell; and in response to determining the range of frequencies is shared by the camping cell, performing the cell reselection based on the cell reselection indication.

Example 5 is the method of Example 1, wherein the cell reselection indication comprises a cell reselection priority that is configured via network signaling.

Example 6 is the method of Example 5, wherein the network signaling is a UE specific configuration, and the cell reselection indication further comprises a validity timer during which the UE specific configuration is valid, and wherein the method further comprises: discarding the UE specific configuration upon expiration of the validity timer.

Example 7 is the method of Example 5, wherein the network signaling is a cell specific configuration of a cell on which the UE is currently camping.

Example 8 is the method of Example 1, wherein the cell reselection indication comprises a TN/NTN specific offset parameter, and wherein the TN/NTN specific offset parameter is used to provide an offset in evaluating a criterion which determines whether the TN cell or the NTN cell is suitable to serve as the camping cell for which the UE performs the cell reselection.

Example 9 is the method of Example 1, wherein the cell reselection indication is obtained via non-access stratum (NAS) signaling and comprises a UE dedicated priority for the TN cell and the NTN cell, and wherein the UE dedicated priority is generated based on UE subscription information that is obtained from the UE.

Example 10 is the method of Example 1, wherein the cell reselection indication is generated per one or more of the following: service, slicing information, UE mobility state, UE battery status, UE location, UE device type, or cell load.

Example 11 is the method of Example 1, wherein the cell reselection indication is indicated in a paging message.

Example 12 is the method of Example 1, wherein the cell reselection indication comprises a redirection message, and wherein the method further comprises: indicating, to the network device, a UE preference for the TN cell or the NTN cell; and obtaining, from the network device, the redirection message that is generated based on the UE preference.

Example 13 is an apparatus for a user equipment (UE), including one or more processors configured to perform steps of the method according to any of Examples 1-12.

Example 14 is a computer readable medium having computer programs stored thereon which, when executed by one or more processors, cause an apparatus to perform steps of the method according to any of Examples 1-12.

Example 15 is a computer program product is provided that includes computer programs which, when executed by one or more processors, cause an apparatus to perform steps of the method according to any of Examples 1-12.

Example 16 is a method for a network device, comprising: generating a cell reselection indication, wherein the cell reselection indication indicates to a user equipment (UE) whether a terrestrial network (TN) cell or a non-terrestrial network (NTN) cell serves as a camping cell for which the UE performs cell reselection; and storing the cell reselection indication in a memory for transmission to the UE.

Example 17 is the method of Example 16, wherein the cell reselection indication comprises a predefined cell reselection priority.

Example 18 is the method of Example 16 or 17, further comprising: generating a frequency reselection indication, wherein the frequency reselection indication indicates to the UE a range of frequencies to be used for communication.

Example 19 is the method of Example 16, wherein the cell reselection indication comprises a cell reselection priority that is configured via network signaling.

Example 20 is the method of Example 16, wherein the cell reselection indication comprises a TN/NTN specific offset parameter, and wherein the TN/NTN specific offset parameter is used to provide an offset in evaluating by the UE a criterion which determines whether the TN cell or the NTN cell is suitable to serve as the camping cell for which the UE performs the cell reselection.

Example 21 is the method of Example 16, further comprising: obtaining UE subscription information from the UE, wherein the cell reselection indication is generated via non-access stratum (NAS) signaling and comprises a UE dedicated priority for the TN cell and the NTN cell, and wherein the UE dedicated priority is generated based on the UE subscription information.

Example 22 is the method of Example 16, wherein the cell reselection indication is indicated in a paging message.

Example 23 is the method of Example 16, wherein the cell reselection indication comprises a redirection message, and wherein the method further comprises: obtaining, from the UE, a UE preference for the TN cell or the NTN cell; and generating the redirection message based on the UE preference.

Example 24 is an apparatus for a network device, including one or more processors configured to perform steps of the method according to any of Examples 16-23.

Example 25 is a computer readable medium having computer programs stored thereon which, when executed by one or more processors, cause an apparatus to perform steps of the method according to any of Examples 16-23.

Example 26 is a computer program product is provided that includes computer programs which, when executed by one or more processors, cause an apparatus to perform steps of the method according to any of Examples 16-23.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but May be modified within the scope and equivalents of the appended claims.

1.-22. (canceled)

23. One or more non-transitory, computer-readable media having instructions that, when executed, cause a user equipment (UE) to:
obtain, from a network device, a cell reselection indication, wherein the cell reselection indication indicates to the UE whether a terrestrial network (TN) cell or a non-terrestrial network (NTN) cell serves as a camping cell for which the UE performs cell reselection; and
perform the cell reselection based on the cell reselection indication.

24. The one or more non-transitory, computer-readable media of claim 23, wherein the cell reselection indication comprises a predefined cell reselection priority.

25. The one or more non-transitory, computer-readable media of claim 23, wherein the instructions, when executed, further cause the UE to:
obtain a frequency reselection indication from the network device, wherein the frequency reselection indication indicates to the UE a range of frequencies to be used for communication; and
perform the cell reselection based on the cell reselection indication within the range of frequencies indicated by the frequency reselection indication.

26. The one or more non-transitory, computer-readable media of claim 23, wherein the instructions, when executed, further cause the UE to:
in response to obtaining the cell reselection indication from the network device, determine the camping cell for which the UE performs the cell reselection;
obtain a frequency reselection indication from the network device, wherein the frequency reselection indication indicates to the UE a range of frequencies to be used for communication;
determine whether the range of frequencies is shared by the camping cell; and
in response to determining the range of frequencies is shared by the camping cell, perform the cell reselection based on the cell reselection indication.

27. The one or more non-transitory, computer-readable media of claim 23, wherein the cell reselection indication comprises a cell reselection priority that is configured via network signaling.

28. The one or more non-transitory, computer-readable media of claim 27, wherein the network signaling is a UE specific configuration, and the cell reselection indication further comprises a validity timer during which the UE specific configuration is valid, and wherein the instructions, when executed, further cause the UE to:
discard the UE specific configuration upon expiration of the validity timer.

29. The one or more non-transitory, computer-readable media of claim 27, wherein the network signaling is a cell specific configuration of a cell on which the UE is currently camping.

30. The one or more non-transitory, computer-readable media of claim 23, wherein the cell reselection indication comprises a TN/NTN specific offset parameter, and wherein the TN/NTN specific offset parameter is used to provide an offset in evaluating a criterion which determines whether the TN cell or the NTN cell is suitable to serve as the camping cell for which the UE performs the cell reselection.

31. The one or more non-transitory, computer-readable media of claim 23, wherein the cell reselection indication is obtained via non-access stratum (NAS) signaling and comprises a UE dedicated priority for the TN cell and the NTN cell, and wherein the UE dedicated priority is generated based on UE subscription information that is obtained from the UE.

32. The one or more non-transitory, computer-readable media of claim 23, wherein the cell reselection indication is generated per service, slicing information, UE mobility state, UE battery status, UE location, UE device type, or cell load.

33. The one or more non-transitory, computer-readable media of claim 23, wherein the cell reselection indication is indicated in a paging message.

34. The one or more non-transitory, computer-readable media of claim 23, wherein the cell reselection indication comprises a redirection message, and wherein the instructions, when executed, further cause the UE to:
indicate, to the network device, a UE preference for the TN cell or the NTN cell; and
obtain, from the network device, the redirection message that is generated based on the UE preference.

35. A method for a network device, comprising:
generating a cell reselection indication, wherein the cell reselection indication indicates to a user equipment (UE) whether a terrestrial network (TN) cell or a non-terrestrial network (NTN) cell serves as a camping cell for which the UE performs cell reselection; and
storing the cell reselection indication in a memory for transmission to the UE.

36. The method of claim 35, wherein the cell reselection indication comprises a predefined cell reselection priority.

37. The method of claim 35, further comprising:
generating a frequency reselection indication, wherein the frequency reselection indication indicates to the UE a range of frequencies to be used for communication.

38. The method of claim 35, wherein the cell reselection indication comprises a cell reselection priority that is configured via network signaling.

39. The method of claim 35, wherein the cell reselection indication comprises a TN/NTN specific offset parameter, and wherein the TN/NTN specific offset parameter is used to provide an offset in evaluating by the UE a criterion which determines whether the TN cell or the NTN cell is suitable to serve as the camping cell for which the UE performs the cell reselection.

40. The method of claim 35, further comprising:
obtaining UE subscription information from the UE,
wherein the cell reselection indication is generated via non-access stratum (NAS) signaling and comprises a UE dedicated priority for the TN cell and the NTN cell, and wherein the UE dedicated priority is generated based on the UE subscription information.

41. The method of claim 35, wherein the cell reselection indication is indicated in a paging message.

42. The method of claim 35, wherein the cell reselection indication comprises a redirection message, and wherein the method further comprises:
obtaining, from the UE, a UE preference for the TN cell or the NTN cell; and
generating the redirection message based on the UE preference.
